(19) United States
(12) Patent Application Publication
(10) Pub. No.: US 2021/0380354 A1
(43) Pub. Date: Dec. 9, 2021

(54) APPARATUS AND METHOD FOR SEPARATING DISHWARE

(71) Applicant: Dishcraft Robotics, Inc., San Carlos, CA (US)

(72) Inventors: Kevin Yuan Ma, Milpitas, CA (US); Paul M. Birkmeyer, San Carlos, CA (US); Nicole Kernbaum, Belmont, CA (US)

(21) Appl. No.: 17/343,683

(22) Filed: Jun. 9, 2021

Related U.S. Application Data
(60) Provisional application No. 63/036,685, filed on Jun. 9, 2020.

(51) Int. Cl. B65G 59/10

(52) U.S. Cl. CPC B65G 59/103; B65G 59/102

(57) ABSTRACT

Apparatus and methods for separating dishware are disclosed. In an embodiment, an apparatus includes a frame that defines an opening through which stacked dishware can pass, and a plurality of assemblies connected to the frame and positioned around the opening. Each assembly includes a base, and a plurality of fingers having a proximal end and a distal end, wherein the plurality of fingers are rotatably coupled to the base and extend from the base towards the opening, wherein each finger tapers towards the distal end.

### CROSS-REFERENCE TO RELATED APPLICATION

This application is entitled to the benefit of provisional U.S. Patent Application Ser. No. 63/036,685, filed Jun. 9, 2020, which is incorporated by reference herein.

### BACKGROUND

When dishware is put into stacks, the dishes may tend to stick together due to geometric wedging (as in the case of some bowls), suction caused by a ring of water at the foot of the wares, or adhesion from food-soil. As a result, lifting the top ware in a stack with a robotic end effector can result in lifting an indeterminate number of wares or no wares at all because the number of wares stuck together may weigh more than the capability of the end effector grasping the top ware, e.g., a magnet end effector.

### SUMMARY

Apparatus and methods for separating dishware are disclosed. In an embodiment, an apparatus includes a frame that defines an opening through which stacked dishware can pass, and a plurality of assemblies connected to the frame and positioned around the opening. Each assembly includes a base, and a plurality of fingers having a proximal end and a distal end, wherein the plurality of fingers are rotatably coupled to the base and extend from the base towards the opening, wherein each finger tapers towards the distal end.

In an embodiment, the plurality of fingers are vertically offset from each other.

In an embodiment, the plurality of fingers are vertically stacked relative to each other.

In an embodiment, the tapering towards the distal end of each finger is configured to enable insertion between articles of dishware.

In an embodiment, the plurality of fingers are rotatably coupled to the base at a pivot that permits rotation of the fingers relative to the base.

In an embodiment, the plurality of fingers are rotatably coupled to the base such that the fingers rotate independently of each other.

In an embodiment, each finger is rotatably coupled to the base by a tensioned pivot mechanism.

In an embodiment, the plurality of fingers are rotatably coupled to the base at respective pivots that permit independent rotation of the fingers in two different directions relative to the base.

In an embodiment, the assemblies include tension mechanisms configured to provide a return force independently to each finger in the plurality of fingers.

In an embodiment, the assemblies are connected to respective robotic arms that are configured to move the assemblies relative to the opening that is defined by the frame.

In an embodiment, a first set of the plurality of fingers is angled to fit between stacked bowls and a second set of the plurality of fingers is angled to fit between stacked plates.

In an embodiment, the first set is vertically stacked above the second set.

In an embodiment, the plurality of fingers includes a first set of fingers having a configuration, and a second set of fingers having a configuration, the configuration of the first set of fingers is different from the configuration of the second set of fingers.

In an embodiment, the plurality of fingers includes upper fingers having a configuration, and lower fingers having a configuration, the configuration of the upper fingers is different from the configuration of the lower fingers. In an embodiment, the configuration of the upper fingers includes a length dimension, the configuration of the lower fingers includes a length dimension and the length dimension of the upper fingers is larger/longer than the length dimension of the lower fingers. In an embodiment, the configuration of the upper fingers includes an angular position at rest relative to a plane and the configuration of the lower fingers includes an angular position at rest relative to the plane, and the angular position at rest of the upper fingers is greater than the angular position at rest of the lower fingers.

In an embodiment, the configuration of the upper fingers includes a length dimension and an angular position at rest relative to a plane, the configuration of the lower fingers includes a length dimension and an angular position at rest relative to the plane, and the length dimension of the upper fingers is larger than the length dimension of the lower fingers and wherein the angular position at rest of the upper fingers is greater than the angular position at rest of the lower fingers.

In an embodiment, the plurality of fingers are rotatably coupled to the base at respective pivot points that permit independent rotation of the fingers in two different directions relative to the base, and the assemblies include a compliant insert configured to provide a return force independently to each finger in the plurality of fingers.

A method for separating stacked dishware is also disclosed. The method involves actuating robotic arms to bring fingers of a plurality of assemblies to a stack of dishware that is located in an opening that is defined by a frame, and causing the fingers to penetrate between two pieces of dishware in the stack of dishware.

In an embodiment, each assembly includes a base and wherein the fingers are rotatably coupled to a respective base, and further comprising allowing the fingers to rotate about the respective bases as the fingers penetrate between two pieces of dishware in the stack of dishware.

In an embodiment, each assembly includes a plurality of vertically offset fingers.

In an embodiment, causing the fingers to penetrate between two pieces of dishware in the stack of dishware involves moving the dishware relative to the assemblies.

In an embodiment, the stack of dishware is a stack of bowls and wherein causing the fingers to penetrate between two pieces of dishware in the stack of dishware involves moving the stack of bowls towards the assemblies such that at least some of the fingers penetrate between two of the stacked bowls.

In an embodiment, causing the fingers to penetrate between two pieces of dishware in the stack of dishware involves moving the assemblies relative to the dishware.

In an embodiment, the stack of dishware is a stack of plates and wherein causing the fingers to penetrate between two pieces of dishware in the stack of dishware involves moving the assemblies towards the stack of plates such that at least some of the fingers penetrate between two of the stacked plates.

In an embodiment, causing the fingers to penetrate between two pieces of dishware in the stack of dishware involves 1) moving the stack of dishware towards the assemblies such that at least some of the fingers penetrate between two pieces of dishware when the stack of dishware is a stack of bowls, and 2) moving the assemblies towards the stack of dishware such that at least some of the fingers penetrate between two pieces of dishware when the stack of dishware is a stack of plates.

In an embodiment, 1) moving the stack of dishware towards the assemblies when the stack of dishware is a stack of bowls causes an upper set of fingers of each assembly to penetrate between at least two bowls in the stack of bowls, and 2) moving the assemblies towards the stack of dishware when the stack of dishware is a stack of plates causes a lower set of fingers of each assembly to penetrate between at least two plates in the stack of plates.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 is a side view of a dish separator assembly that includes a plurality of fingers configured to separate dishes from a stack of dishes.

FIG. 2 depicts another side view of the dish separator assembly of FIG. 1.

FIG. 3 is a perspective view of the dish separator system depicted in FIGS. 1 and 2.

FIG. 4 is a side view of another embodiment of a dish separator assembly in which the fingers are rotatably coupled to a base.

FIG. 5 depicts another side view of the dish separator assembly of FIG. 4.

FIG. 6 is a perspective view of the dish separator system depicted in FIGS. 4 and 5.

FIG. 7 depicts a stack of plates relative to a stack of bowls with the stack of plates and the stack of bowls positioned so that the top central surface of the top plate and the top central surface of the top bowl are at the same vertical position.

FIG. 8 is a top view of a dish separator assembly as shown in FIGS. 4-6.

FIG. 9 depicts an embodiment of a dish handling system in which four dish separator assemblies are connected to a frame that defines an opening through which stacked dishware (not shown) can pass.

FIGS. 10A is a top view of the dish handling system shown in FIG. 9 with the dish separator assemblies positioned away from where a stack of dishware would be located in the opening.

FIGS. 10B is a top view of the dish handling system shown in FIG. 9 with the dish separator assemblies positioned near where a stack of dishware would be located in the opening.

FIG. 11 is a perspective view of an embodiment of a dish separator assembly in which the fingers are rotatably coupled to a base via pins and compliant inserts.

FIG. 12 is a process flow diagram of a method for separating stacked dishware.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In a robotic dish handling system where there is a grabber that expects to grab only a single dish from the top of the stack, the problem of wares sticking together may cause issues such as jamming of the robotic system, dropped wares, or failed picks. In some implementations, the disclosed dish handling system may be used to allow for the grasping of only a single top dish by constraining the bottom dishes and prying apart the top dish from the dish immediately below it. The terms dishware, ware, and dish may be used interchangeably herein to refer to articles of dishware such as plates, bowls, cups, pots, pans, lids and other articles that are used to prepare, serve, hold, carry, and/or transport food or beverages for human consumption.

As described herein, a dish handling system that includes multiple dish separator assemblies may urge fingers of the dish separator assemblies between dishes where the fingers are configured as described herein. The fingers may act as a series of leaf springs with wedges on the end. In an embodiment, the fingers may be configured to interact with both bowls and plates while keeping the top center of the wares in approximately (e.g., within a tolerance of between 0.5 to 5 cm) of the same position to allow for simplified path planning for a destack arm. This means that the fingers that interact with bowls may be higher than the fingers that interact with plates. The compliant (e.g., flexible) nature of the fingers may allow for 1) preloading the fingers on the sides of a bowl and thus achieving a good position to pry two bowls apart, 2) compliance for when a dish stack lift system moves to change the angle to act as a lever arm when prying apart plates, 3) compensating for wares that are not well centered with the destack arm pick position, 4) compensating for wares that are skewed, 5) compensating for tolerance in the vertical positioning of wares, and 6) creating compliance in the dish handling system so that when a destack arm drops down to pick the top dish, the destack arm does not impact the wares or dish stack lift system (through the load path) with significant force. Another beneficial result of creating compliance in the dish handling system is that the fingers may also reduce the sound created when separating dishes and the wear on the system and the dishes that may otherwise be created during the separating action. Multiple fingers for both bowls and plates gives flexibility to separate wares when the wares are poorly stacked (and skewed) or when there is some error in vertical position estimation.

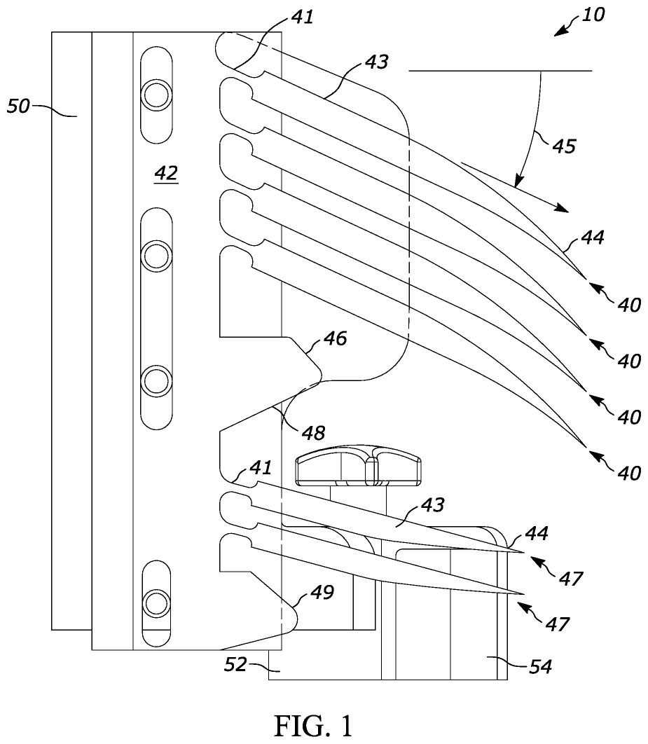

FIG. 1 is a side view of a dish separator assembly 10 that includes a plurality of fingers configured to separate dishes from a stack of dishes. With reference to FIG. 1, the fingers may include upper fingers 40 that are attached by a reduced thickness portion 41 to a base 42 that permits flexing relative to the base 42. For example, the reduced thickness portion may be a thin region of between 1-3 mm to permit flexing. The upper fingers 40 may include a rigid portion 43 coupled to the reduced thickness portion 41 and having a greater thickness perpendicular to its longitudinal axis (longitudinal axis being defined as a direction from a point of attachment to the base 42 and a tip (distal end) of a finger 40). For example, the rigid portion 43 may be between two and eight times as thick as the reduced thickness portion 41 such that the rigid portion 43 is permitted to rotate about the connection to the base due to flexing of the reduced thickness portion 41 but does not buckle in response to axial forces, e.g., forces acting substantially parallel (e.g., within 15 degrees of parallel) to the longitudinal axis. In some embodiments, the reduced thickness portion 41 may be replaced with a spring loaded hinge to permit similar flexing. The rigid portion 43 may be rigid in that it is less flexible than the reduced thickness portion 41 but may still flex somewhat in use. The rigid portion 43 of a finger 40 may transition to a wedge or tapered portion 44 at the distal end that narrows from the thickness of the rigid portion 43 to a point (e.g., a radius at the distal end or tip of between 1 and 5 mm).

As illustrated in FIG. 1, the upper fingers 40 define an angle 45 with respect to the horizontal plane, e.g., the longitudinal direction of a finger 40 as defined above may define the angle 45. The angle 45 may be between 45 and 15 degrees, preferably between 20 and 35 degrees. In an embodiment, the angle of the upper fingers is set to an angle that matches an angle between two dishes in a stack of dishes (e.g., between two bowls in a stack of bowls) so that a finger of the upper fingers can more easily wedge between the two stacked dishes. Note further that the tapered end portions 44 of the fingers may also be further angled or curved downwardly relative to the rigid portion 43 of the fingers. The angle 45 and angle or curve of the tapered end portion 44 of the fingers may facilitate insertion between two stacked bowls.

In some embodiments, a stop 46 may project from the base 42 and define a surface that engages a bottom most finger of the upper fingers 40 to limit the finger's downward movement and to prevent the finger from collapsing against the base 42.

The fingers may further include lower fingers 47 that are vertically offset from, or vertically stacked relative to, each other and that are vertically offset from, or vertically stacked relative to, the upper fingers 40. The lower fingers 47 may have similar parts (e.g., a reduced thickness portion 41, a rigid portion 43, and a tapered end portion 44) as the upper fingers 40. However, the lower fingers 47 may define a smaller angle 45 (e.g., between 0 and 25 degrees), have points of attachment to the base 42 that are offset below the points of attachment of the upper fingers 40 to the base 42, and the tapered end portions 44 may be angled or curved upward or be straight relative to the rigid portion 43. In an embodiment, the angle of the lower fingers is set to an angle that matches an angle between two dishes in a stack of dishes (e.g., between two plates in a stack of plates) so that a finger of the lower fingers can more easily wedge between the two stacked dishes. As shown in FIG. 1, absent external forces applied to the fingers 40, 47, the tips of the lower fingers 47 are below the tips of the upper fingers 40 and the two different sets of fingers are separated therefrom by a gap. Note also that the upper fingers 40 may be longer (e.g., 3 to 8 cm longer) than the lower fingers 47. As is described in more detail below, the upper fingers are longer than the lower fingers so that a top dish can be separated from a stack of dishes with the center of the dish at the same vertical position regardless of whether the dish is a plate or a bowl.

An upper stop surface 48 may project from the base 42 (such as on the same projection defining stop 46) above the lower fingers 47 and engage the lower fingers 47 to limit upward rotation of the lower fingers. A lower stop surface 49 may project from the base 42 below the lower fingers 47 to limit downward rotation of the lower fingers 47. Note that the surfaces 46, 48, 49 of the stops may be angled to substantially match (e.g., within 5 degrees) the angle of those rigid portions 43 of the fingers 40, 47 that contact the surfaces when the rigid portions 43 are rotated into contact with the surfaces.

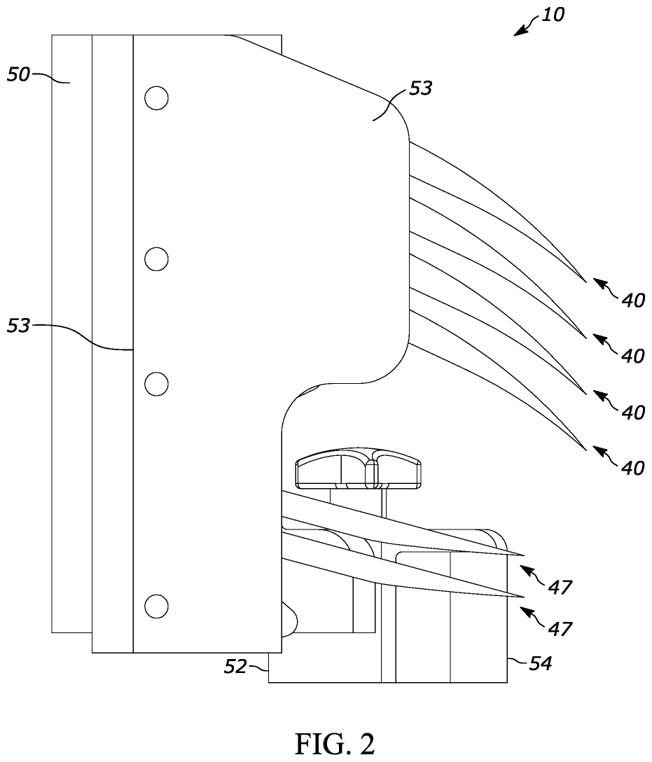

With reference to FIG. 2, out of plane (e.g., the plane of the drawing page as shown in FIGS. 1 and 2) movement of the fingers 40, 47 may be reduced by constraining at least the reduced thickness portions 41 of the fingers between the plate 50 and a cover plate 53. In the embodiment of FIGS. 1-3, a portion of the cover plate 53 projects outward along the upper fingers 40 (but not the lower fingers 47) to further limit out of plane movement of the upper fingers 40. In some embodiments, the base 42 and the fingers 40, 47 are cut from a single layer of material of substantially (within 1 mm) uniform thickness or molded as a single piece of plastic material. The fingers 40, 47 may slide between the plate 50 and the plate 53 during operation.

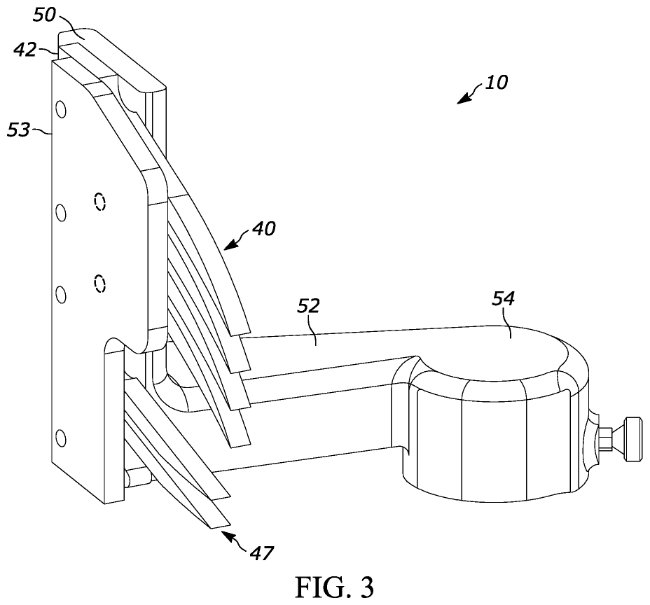

FIG. 3 is a perspective view of the dish separator system depicted in FIGS. 1 and 2. As shown in FIGS. 1-3, the base 42 may fasten to a plate 50 mounted to a distal end of an arm 52 that is secured to a mount 54 that is secured to a rotational actuator for rotating the fingers 40, 47 into engagement with wares as described below.

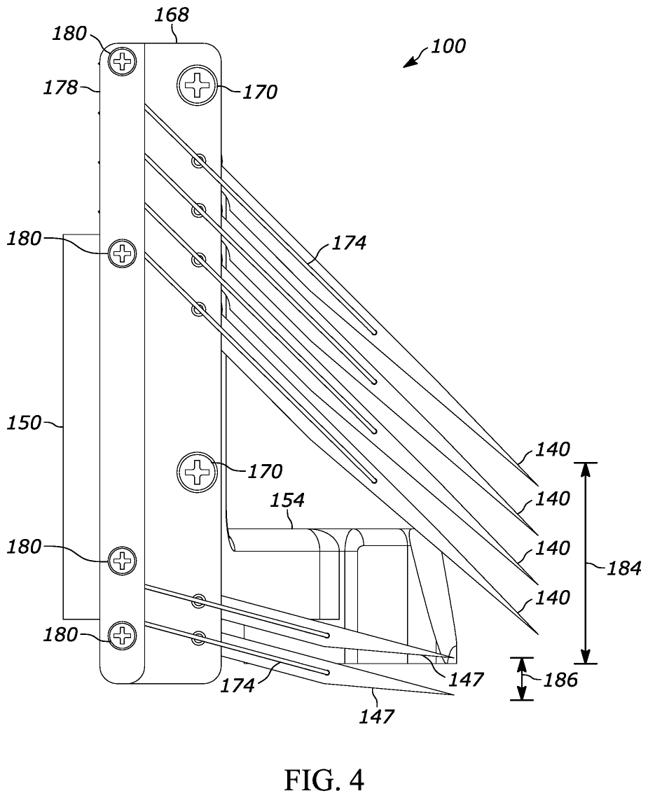

In the embodiment described with reference to FIGS. 1-3, flexibility of the fingers to rotate is provided through the thin portions 41 of the molded plastic structure that includes the base 42 and the upper and lower fingers 40 and 47. The rotatable coupling of the fingers to the base enables the fingers to rotate as the fingers wedge between dishes and the flexible thin portion 41 in the upper and lower fingers causes the fingers to return to the at rest, or untensioned, position after the fingers are disengaged from a stack of dishes. Although FIGS. 1-3 depict one example of a dish separator assembly that exhibits flexibility of the fingers to rotate independently of each other, other configurations are possible. For example, other embodiments of a dish separator assembly are described with reference to FIGS. 4-6 and FIG. 11.

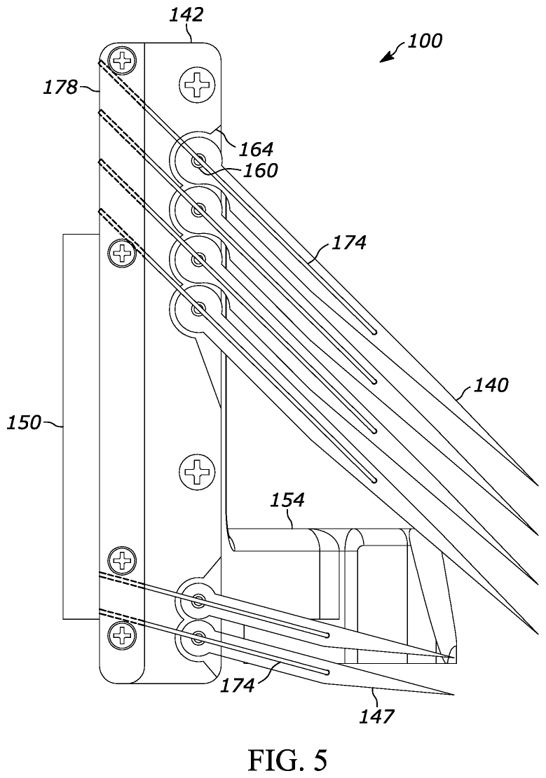

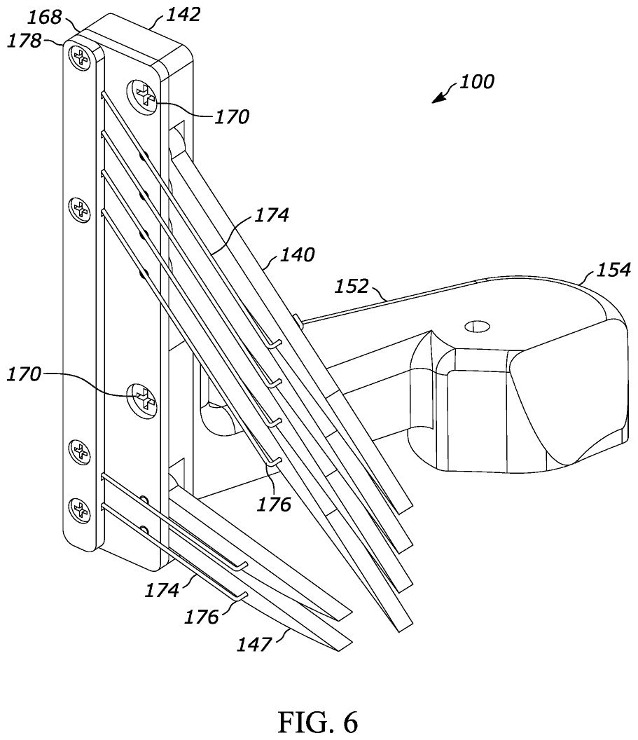

FIG. 4 is a side view of another embodiment of a dish separator assembly 100 in which the fingers are rotatably coupled to a base. In the embodiment of FIG. 4, the dish separator assembly includes a base 142, upper fingers 140, and lower fingers 147. The dish separator assembly may also include an arm 152 (see FIG. 6) and a mount 154 (see FIG. 6) similar to those described above with reference to FIGS. 1-3. FIG. 5 is a side view of the dish separator assembly 100 of FIG. 4 that shows some internal rotational and tension features associated with the fingers and FIG. 6 is a perspective view of the of the dish separator assembly 100 of FIGS. 4 and 5.

With reference to FIGS. 5 and 6, the fingers 140, 147 are connected to the base 142 at respective rotatable joints 160 such that the fingers are able to independently rotate about a pivot point in both directions in the plane of the drawing. In an embodiment, the base includes a first base plate (element 142, FIGS. 5 and 6) that includes fitted cavities 164 in which the proximal ends of the fingers can sit and be secured by the pivot pins. The distal ends of the fingers are secured in place between the first base plate (element 142, FIGS. 5 and 6) and a second base plate 168 (FIGS. 4 and 6), in which the first and second base plates are held together by at least two screws 170. Each finger is tensioned by a tension bar 174 that runs in parallel to each corresponding finger. With reference to FIG. 6, each tension bar includes a hooked distal end 176 that is connected to the corresponding finger at a through hole that runs completely through the corresponding finger and forms openings at two side walls of the finger. Each tension bar includes a straight proximal end that is secured into the base by a tension bar plate and the second base plate. For example, as shown in FIG. 6, a tension bar plate 178 includes channels that are configured to snuggly fit the straight proximal end of the corresponding tension bars at a particular angle. In FIG. 4, portions of the tension bars 174 are not visible behind the tension bar plate 178 and in FIG. 5, the locations of the tension bars 174 are shown relative to the tension bar plate 178. In the embodiment of FIGS. 4-6, the tension bar plate 178 is attached to the first and second base plates by four screws 180. In an embodiment, the tension bars are metallic bars (e.g., stainless steel) that provide tension to the fingers when the fingers rotate in either direction relative to an “at rest” or “untensioned” state of the fingers. When no external force is applied to the fingers, the tension bars are in the at rest, or untensioned state, and no rotational forces are applied to the fingers. However, when an external force is applied to one or more of the fingers, the tension bars exert a restoring force in the opposite direction to the external force that imparts a rotational force on the finger or fingers about the pivot points and in the direction of the restoring force. The amount of flexibility of the fingers relative to the base is a design choice and can be controlled by controlling various parameters of the tension mechanism, including for example, the flexibility of the tension bars (e.g., by controlling the material, thickness, and/or length of the tension bars), how and where the tension bars are attached to the base, and how and where the tension bars are attached to the fingers. In an embodiment, the tension bars are stainless steel metal rods with a diameter in the range of about 1-3 cm, although other diameter tension bars may be used. FIGS. 4 and 5 also show an attachment plate 150 that is connected to the arm 152 and provides a way to connect the base 142 to the arm 152.

In the embodiment of FIGS. 4-6, the upper fingers 140 include a set of four fingers similar to the upper fingers 40 in the embodiment of FIGS. 1-3 and the lower fingers 147 include a set of lower fingers similar to the lower fingers 47 in the embodiment of FIGS. 1-3. As shown in FIGS. 4-6, the upper fingers 140 include four separate individually rotatable fingers that are vertically offset from each other, or vertically stacked relative to each other, and that are tapered towards their distal ends. The vertical offset between the upper fingers enables separation of dishes to be accomplished with less precise control over the movements/positioning of the dish separator assembly relative to a stack of dishes than if only one finger were used. That is, the vertically offset fingers provides a vertical operating dimension that spans roughly between the top finger of the upper fingers and the bottom finger of the upper fingers. For example, with reference to FIG. 4, the tips of the upper fingers are vertically spaced apart by approximately 1 cm (e.g., ±20%) and the vertical offset of the upper fingers creates a vertical operating dimension 184 in the range of approximately 3-5 cm (±20%), which provides a margin of error of movement for the corresponding robotic arm and dish stack lift system that may be part of a dish handling system. In addition to being vertically offset from each other, the upper fingers are also tapered towards the distal ends of the fingers. The tapering of the fingers enables the fingers to be inserted, or wedged, between two articles of dishware, for example, between two bowls that are stacked on top of each other. In an embodiment, the upper fingers are tapered on one side (e.g., the downward facing side) and the tapering forms an angle of about 5.5 degrees (±20%) at the distal ends of the fingers. Other angles of tapering of the upper fingers are possible and in an embodiment, the tapering may be in the range of 3-30 degrees. Additionally, although the fingers are tapered on only one side, the fingers could be tapered on both sides and although there are four upper fingers in the example of FIGS. 4-6, there could be a different number of upper fingers. Although it has been found that multiple vertically offset fingers provides a margin of error for movement/positioning of the dish separator assembly, in an embodiment, a single upper finger could be used. Additionally, although certain dimensions are provided as examples, other dimensions are possible.

As shown in FIGS. 4-6, the lower fingers 147 include two separate fingers that are vertically offset from each other, or vertically stacked relative to each other, and that are tapered towards their distal ends. In an embodiment, the tips of the lower fingers are separated by approximately 1 cm (e.g., ±10%) although other dimensions are possible depending on how tightly the dishes (e.g., plates) are stacked. The vertical offset between the lower fingers enables separation of dishes to be accomplished with less precise control over the movements/positioning of the dish separator assembly than if only one finger were used. That is, the vertically offset fingers provides a vertical access dimension that spans between the top finger of the lower fingers and the bottom finger of the lower fingers. For example, with reference to FIG. 4, the vertical offset of the lower fingers creates a vertical operating dimension 186 of about 1-3 cm (±20%), which translates to a margin of error of movement for the corresponding robotic arm and dish stack lift system that may be part of a dish handling system. In addition to being vertically offset from each other, the lower fingers are also tapered towards the distal ends of the fingers. The tapering of the fingers enables the fingers to be inserted, or wedged, between two articles of dishware, for example, between two plates that are stacked on top of each other. In an embodiment, the lower fingers are tapered on one side (e.g., the downward facing side) and the tapering forms an angle of about 10 degrees (±20%) at the distal ends of the fingers. Other angles of tapering of the lower fingers are possible and in an embodiment, the tapering may be in a range of 5-30 degrees. Additionally, although the fingers are tapered on only one side, the fingers could be tapered on both sides. Although there are two lower fingers in the example of FIGS. 4-6, there could be a different number of lower fingers and although it has been found that multiple vertically offset fingers provides a margin of error for movement/positioning of the dish separator assembly, in an embodiment, a single lower finger could be used. Additionally, although certain dimensions are provided as examples, other dimensions are possible. In an embodiment, the upper and lower fingers are made from plastic, such as polyoxymethylene (POM), which exhibits high stiffness, low friction, and high dimensional stability, although other material may be used.

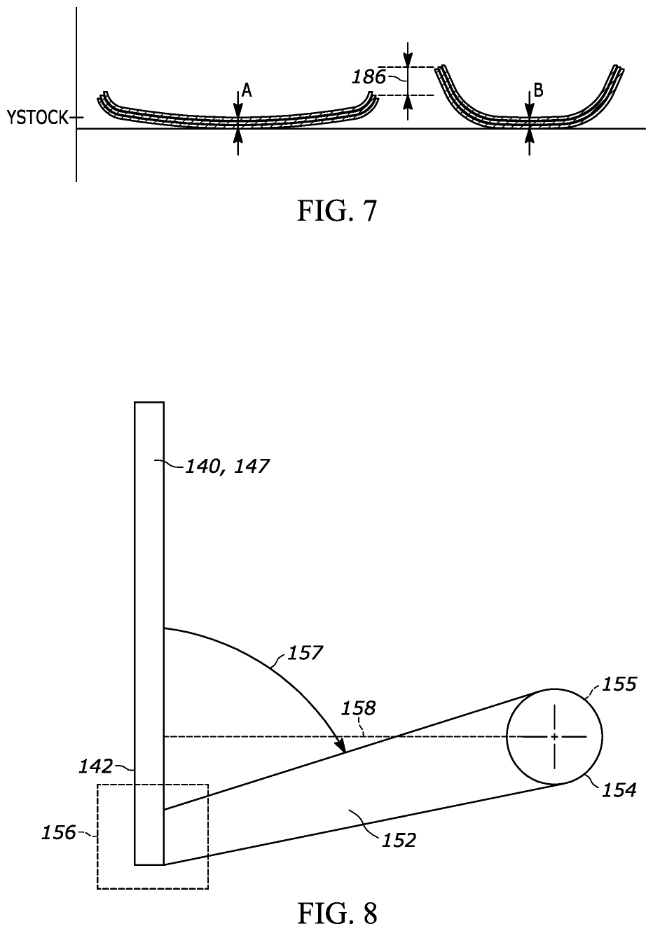

In the dish separator assembly 100 described with reference to FIGS. 4-6, the upper fingers 140 and lower fingers 147 have different lengths and are configured at different angles relative to a vertical axis and/or relative to each other. In an embodiment, the dish separator assembly is configured to handle different types of dishes, in particular, to handle both stacks of plates and stacks of bowls. Additionally, in a dish handling system that uses a dish stack lift system to lift a stack of dishware and a robotic arm and magnetic grabber to remove dishes from the stack, it may be beneficial to have the magnetic grabber engage the dishes at the same position (e.g., at the same vertical position) whether the dishes are plates or bowls. For example, FIG. 7 depicts a stack of plates relative to a stack of bowls with the stack of plates and the stack of bowls positioned so that the top central surface of the top plate (point A) and the top central surface of the top bowl (point B) are at the same vertical position (e.g., the same position on the y-axis). As illustrated in FIG. 7, when the top plate in the stack of plates and the top bowl in the stack of bowls are positioned such that their top central surfaces (points A and B) are at the same vertical position, the finger insertion point between the top two bowls (e.g., the gap between the top lip of the top two bowls) is at a different vertical position than the finger insertion point between the top two plates (e.g., the gap between the top lip of the top two plates). Specifically, as indicated by arrow 186, the gap between the lip of the top plate and the next plate in the stack of plates is lower on the y-axis than the gap between the lip of the top bowl and the next bowl in the stack of bowls. With this criteria in mind, the fingers of the dish separator assembly 100 of FIGS. 4-6 are specifically designed to separate both plates and bowls when the top central surface of the top plate in a stack of plates and the top central surface of the top bowl in a stack of bowls are at approximately the same vertical position (e.g., within about 0.2-1.2 cm). In particular, the upper fingers 140 are positioned and designed specifically to separate bowls based on the geometry of a stack of bowls and the lower fingers 147 are positioned and designed specifically to separate plates based on the geometry of a stack of plates when the top central surface of the top plate in a stack of plates and the top central surface of the top bowl in a stack of bowls are at approximately the same vertical position.

Referring back to FIGS. 4-6, the upper fingers 140 are configured specifically to separate the top bowl from a stack of bowls and the lower fingers 147 are configured to separate the top plate from a stack of plates. With respect to the upper fingers, the upper fingers have a length and are positioned at an angle that is configured to promote wedging of the fingers between bowls in a stack of bowls. The length of fingers is such that the fingers can wedge between two bowls and the angle of fingers is configured to correspond to the angle of the sides of the bowls in the stack of bowls. With respect to the lower fingers, the lower fingers have a length and are positioned at an angle that is configured to promote wedging of the fingers between plates in a stack of plates. As shown in FIGS. 4-6, the upper fingers are longer than the lower fingers and the upper fingers are at a steeper angle than the lower fingers at least because the upper fingers are configured to separate bowls in a stack of bowls and the lower fingers are configured to separate plates in a stack of plates. Thus, the configuration of the two different sets of fingers, e.g., the upper fingers and the lower fingers, is such that the dish separator assembly 100 can be used to effectively separate bowls from a stack of bowls and plates from a stack of plates using the same dish separator assembly. Similar design considerations apply to dish separator assembly 10 described with reference to FIGS. 1-3 and FIG. 11 and would apply as well to other variations of dish separator assemblies.

Additionally, in the embodiments of FIGS. 1-6 and FIG. 11, the dish separator assembly includes more upper fingers than lower fingers because stacks of bowls can be more unevenly stacked (e.g., due to “tilted” bowls) than stacks of plates and thus the position of the gaps between bowls in a stack of bowls can vary over a wider range than the position of the gaps between plates in a stack of plates.

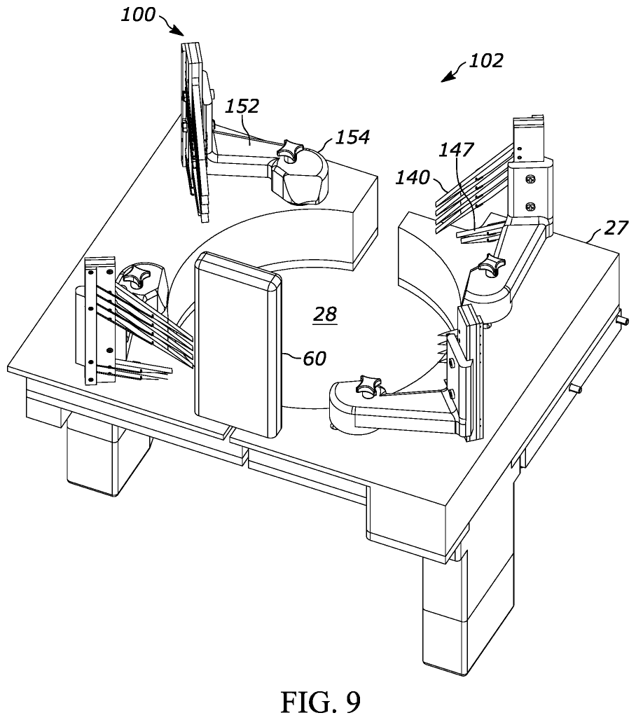

FIG. 8 is a top (e.g., bird's eye) view of a dish separator assembly as shown in FIGS. 4-6. With reference to FIG. 8, the mount 154 may define an axis of rotation 155. The arm 152 may extend from the mount to a region 156 where the arm 152 attaches to the plate 150 (not shown). The upper and lower fingers 140, 147 then extend outwardly from this region. The plane parallel to which the fingers 140, 147 move (e.g., rotate about pivots 160) during operation (e.g., move substantially parallel to: within 5 degrees) may define an angle 157 with respect to the arm that is less than 90 degrees, e.g., between 80 and 60 degrees. This plane may also be defined as a plane perpendicular to the direction of substantially uniform thickness of the upper and lower fingers 140, 147 and the base 142. That is, as shown in FIG. 8, the base and the fingers 140, 147 have a substantially uniform thickness, or width, from the backmost portion of the base 142 to the distal ends of the fingers 140, 147. Stated differently, a line 158 perpendicular to the plane of movement and intersecting the axis of rotation 155 will be offset from the region 156 at which the arm 152 connects to the plate and the line 158 may intersect the fingers 140, 147.

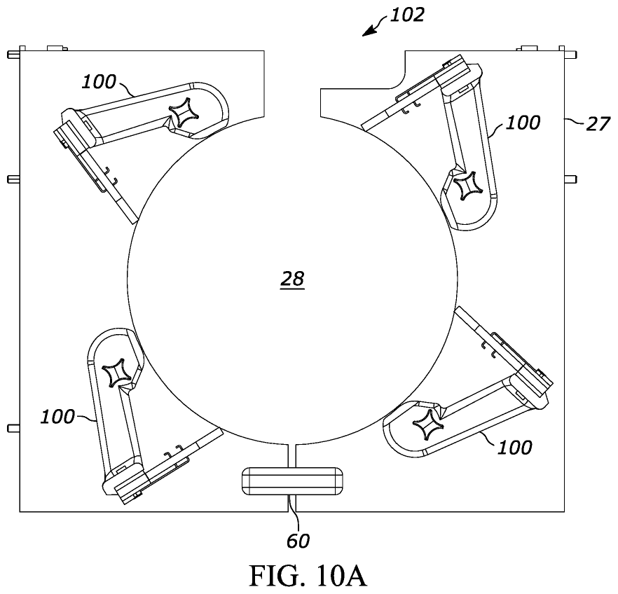

In an embodiment, multiple dish separator assemblies are attached to a frame of a dish handling system. FIG. 9 depicts an embodiment of a dish handling system 102 in which four dish separator assemblies 100 are connected to a frame 27 that defines an opening 28 through which stacked dishware (not shown) can pass. In an embodiment, a dish stack lift system is configured to lift a stack of dishware up through the opening and is operated in conjunction with the dish separator assemblies to ensure that the dishes are separated from each other before a top dish is removed from the stack by a destack are, e.g., a destack arm with a magnetic grabber. As shown in FIG. 9, four dish separator assemblies 100, each including fingers 140, 147, a plate 150, an arm 152, and a mount 154 may be mounted to a top plate 27 of the dish handling system and distributed substantially (e.g., within 5 degrees of) uniformly around an opening 28 defined by the top plate 27. In other embodiments, only two or three dish separator assemblies are used. In still other embodiments, more than four dish separator assemblies are used. The dish handling system shown in FIG. 9 includes dish separator assemblies as described with reference to FIGS. 4-6, although the dish handling system could use dish separator assemblies as described with reference to FIGS. 1-3.

In the embodiment shown in FIG. 9, the dish handling system 102 includes a dish guard 60. The dish guard 60, e.g., a solid piece of material, may be placed near an outward facing side of the dish handling system to prevent dishes that have been dropped by a destack arm or tipped over from the stack of dishes on the dish stack lift system from falling out towards the user when the user opens a door to the dish stack lift system. In the illustrated embodiment, the dish guard mounts near (within 1-5 cm) one edge of the top plate 27 and projects upwardly therefrom.

The dish separator assemblies 100 may use, 1, 2, 3, 4, or other number of sets of compliant fingers 140, 147 to wedge apart the wares. A machine vision system may be used to identify the type of ware and to estimate the orientation (or pose) of the wares (which may be skewed due to poor stacking or objects stuck between wares) and to estimate the location of the ware in space. For example, a machine learning model may be trained to receive an image from a camera and to output a classification of a type of ware represented in the image. After a ware is recognized, the pose of the ware can be estimated using one of several neural networks that perform regression on the pose or through established algorithms such as those based on iterative closest point approaches.

A controller may use a dish stack lift system to position the top ware in a stack of wares to the appropriate height within the opening 28 for the dish separator assemblies to engage the sets of fingers 140, 147. Each ware type has a corresponding height fitted per its ware type and size. In the case of plates, the lower fingers 147 are inserted between the wares to separate the top plate from the next plate in the stack. For bowls, the upper fingers 140 are preloaded against the side of the bowls and then the dish stack lift system raises the stack of bowls, pushing the bowls against the fingers 147, which causes the fingers to wedge between the bowls, separating the bowls, e.g., separating the top bowl from the next bowl in the stack. In an embodiment, an upward lift of the stack of bowls by a lift mechanism of the dish stack lift system causes the upper fingers 147 to wedge or penetrate between the side of the top bowl and the lip of the bowl beneath the top bowl, creating separation between the two bowls. In some embodiments, only engaging of the upper fingers 147 by movement of the dish separator assembly, without subsequent lifting of the stack of bowls, is sufficient to achieve separation of two bowls such that lifting of the stack following engaging the fingers 147 may be omitted. For the plates, the arms 152 are rotated about the mounts 154, in order to push the lower fingers 147 inwardly and between the stacked plates, which wedges at least one lower finger between two adjacent plates (e.g., penetrates between plates) and pries the adjacent plates apart.

In an embodiment, a machine vision system and a dish stack lift system may be used to locate wares to facilitate separation of the wares. A controller controlling movement of the arms 152 may be defined with different set positions, e.g., pivoting inward toward the opening 28 by different amounts during separation, so that each ware can have a different set position of the arms 152. Machine vision using images from nearby cameras may also be used to help determine the position and the vertical height of the dishes and how the dishes are positioned so the dish stack lift system can be adjusted appropriately. The machine vision system may provide instructions to the lift mechanism of the dish stack lift system on how high to raise a given stack of dishes to facilitate separation. For each ware, the machine vision system can identify the type of ware and its approximate center and orientation. This information can be used to raise the ware to a height such that the top two or three wares are vertically aligned with ends of the fingers 140 or 147 to facilitate wedging of the fingers 140 or 147 between the top two or three wares. Upon completion of positioning the top most dish, the controller or module of the controller managing the dish handling system may receive a dish input instruction and, in response, engage the dish separator assemblies, e.g., instruct motors of the dish separator assemblies to pivot the arms 152 inward thereby engaging the fingers 140 or 147 with the ware. Where the top ware is identified using machine vision as a bowl, the controller may cause the dish stack lift system to raise a lift paddle after closing of the dish separator assemblies in order to urge the fingers 147 of the dish separator assemblies down beneath the top bowl and the bowl below it (“Move lift up by dish type”). As noted above, the amount of lift may be pre-programmed and may vary with respect to the height of the bowls identified and classified using machine vision. As noted above, plates may be separated in some embodiments without additional lifting from the stack top position by rotating the fingers 147 towards the plates.

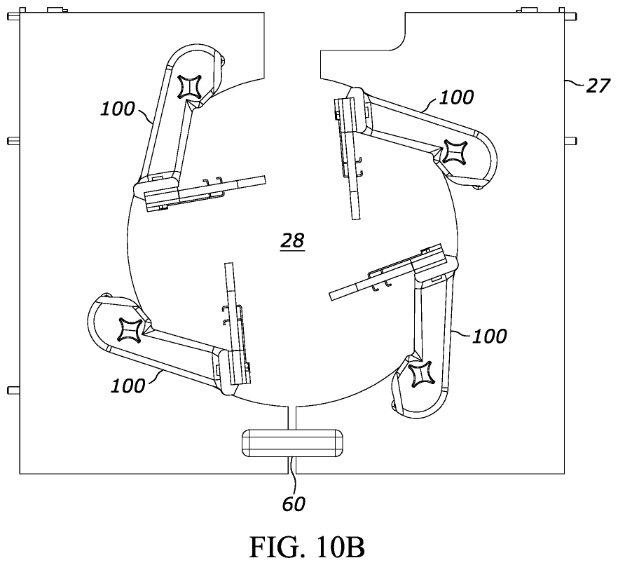

FIGS. 10A and 10B are top views of the dish handling system 102 shown in FIG. 9 with the dish separator assemblies 100 in two different positions.

In the example of FIG. 10A, the dish separator assemblies are positioned away from where a stack of dishware (e.g., plates or bowls) would be located in the opening. In the example of FIG. 10B, the dish separator assemblies are positioned closer to the center of the opening 28 in positions that would allow the fingers 140, 147 to engage with stacked dishware (not shown). In an embodiment, the dish separator assemblies rotate about the mounts 154 so that the fingers 140, 147 are faced towards the opening to engage and disengage with stacked dishware that is being lifted up to the opening. The configuration of the dish handling system 102 described with reference to FIGS. 9, 10A, and 10B applies also to the dish separator assembly described with reference to FIGS. 1-3 and FIG. 11.

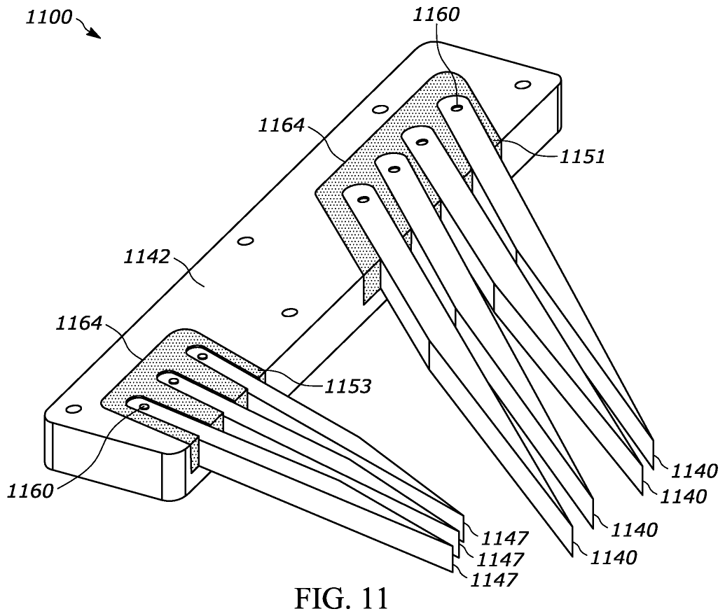

An alternative embodiment of a dish separator assembly is shown in FIG. 11. An elastomeric material (shown as dot pattern shading) may be used between fingers of the dish separator assembly and the base to provide compliance and/or return fingers to an initial position. For example, a molded elastomer material with defined stiffness and wear properties could maintain a desired finger angle to high precision over long periods of time. A dish separator assembly with an elastomer compliant insert as a tension mechanism may be easier to implement than an assembly with metal springs since the part count would be lower and finger position would be pre-determined by part geometry. An elastomer assembly may be more cost effective than a custom metal spring assembly, and easier to assemble during manufacturing and disassemble for cleaning.

FIG. 11 is a perspective view of an embodiment of a dish separator assembly 1100 in which the fingers are rotatably coupled to a base via pins and compliant inserts. In the embodiment of FIG. 11, the dish separator assembly includes a base 1142, upper fingers 1140, and lower fingers 1147. The dish separator assembly may also include an arm (not shown) and a mount (not shown) similar to those described above with reference to FIGS. 1-6.

With reference to FIG. 11, the fingers 1140, 1147 are connected to the base 1142 by respective pins 1160 such that the fingers are able to independently rotate about the pins (pivot points) in both directions. In the embodiment of FIG. 11, the base includes fitted cavities 1164 in which the proximal ends of the fingers can sit and be secured by the pins. Each cavity includes a compliant insert 1151 and 1153 that is custom molded to match the shape of the cavity and to match the shape of the proximal ends of the fingers (e.g., to form fit around the proximal ends of the fingers). As shown in FIG. 11, the compliant insert is directly adjacent to opposite side surfaces at the proximal ends of the fingers. In an embodiment, the compliant inserts are elastomeric material that provide forces to the fingers when the fingers rotate in either direction relative to an “at rest” state of the fingers. When no external force is applied to the fingers, the compliant insert is in an at rest, or uncompressed state, and no rotational forces are applied to the fingers. However, when an external force is applied to one or more of the fingers, portions of the compliant insert are compressed, causing the compliant insert to exert a restoring force in the opposite direction to the external force that imparts a rotational force on the finger or fingers about the pivot points and in the direction of the restoring force. The amount of flexibility of the fingers relative to the base is a design choice and can be controlled by controlling various parameters of the compliant insert, including for example, the flexibility of the elastomeric material and the distribution of the elastomeric material around the fingers.

In the embodiment of FIG. 11, the upper fingers 1140 include a set of four fingers similar to the upper fingers 40, 140 in the embodiment of FIGS. 1-6 and the lower fingers 1147 include a set of lower fingers similar to the lower fingers 47, 1147 in the embodiment of FIGS. 1-6. As shown in FIG. 11, the upper fingers 1140 include four separate individually rotatable fingers that are vertically offset from each other, or vertically stacked relative to each other, and that are tapered towards their distal ends. The vertical offset between the upper fingers is dictated in part by the dimensions of the compliant insert and enables separation of dishes to be accomplished with less precise control over the movements/positioning of the dish separator assembly relative to a stack of dishes than if only one finger were used. That is, the vertically offset fingers provide a vertical operating dimension that spans roughly between the top finger of the upper fingers and the bottom finger of the upper fingers. For example, with reference to FIG. 11, the tips of the upper fingers are vertically spaced apart by approximately 1 cm (e.g., ±20%) and the vertical offset of the upper fingers creates a vertical operating dimension in the range of approximately 3-5 cm (±20%), which provides a margin of error of movement for the corresponding robotic arm and dish stack lift system that may be part of a dish handling system. In addition to being vertically offset from each other, the upper fingers are also tapered towards the distal ends of the fingers. The tapering of the fingers enables the fingers to be inserted, or wedged, between two articles of dishware, for example, between two bowls that are stacked on top of each other. In an embodiment, the upper fingers are tapered on one side (e.g., the downward facing side) and the tapering forms an angle of about 5.5 degrees (±20%) at the distal ends of the fingers. Other angles of tapering of the upper fingers are possible and in an embodiment, the tapering may be in the range of 3-30 degrees. Additionally, although the fingers are tapered on only one side, the fingers could be tapered on both sides and although there are four upper fingers in the example of FIGS. 4-6, there could be a different number of upper fingers. Although it has been found that multiple vertically offset fingers provides a margin of error for movement/positioning of the dish separator assembly, in an embodiment, a single upper finger could be used. Additionally, although certain dimensions are provided as examples, other dimensions are possible.

As shown in FIG. 11, the lower fingers 1147 include three separate fingers that are vertically offset from each other, or vertically stacked relative to each other, and that are tapered towards their distal ends. In an embodiment, the tips of the lower fingers are separated by approximately 1 cm (e.g., ±10%) although other dimensions are possible depending on how tightly the dishes (e.g., plates) are stacked. The vertical offset between the lower fingers enables separation of dishes to be accomplished with less precise control over the movements/positioning of the dish separator assembly than if only one finger were used. That is, the vertically offset fingers provides a vertical access dimension that spans between the top finger of the lower fingers and the bottom finger of the lower fingers. For example, with reference to FIG. 11, the vertical offset of the lower fingers creates a vertical operating dimension of about 1-3 cm (±20%), which translates to a margin of error of movement for the corresponding robotic arm and dish stack lift system that may be part of a dish handling system. In addition to being vertically offset from each other, the lower fingers are also tapered towards the distal ends of the fingers. The tapering of the fingers enables the fingers to be inserted, or wedged, between two articles of dishware, for example, between two plates that are stacked on top of each other. In an embodiment, the lower fingers are tapered on one side (e.g., the downward facing side) and the tapering forms an angle of about 10 degrees (±20%) at the distal ends of the fingers. Other angles of tapering of the lower fingers are possible and in an embodiment, the tapering may be in a range of 5-30 degrees. Additionally, although the fingers are tapered on only one side, the fingers could be tapered on both sides. Although there are three lower fingers in the example of FIG. 11, there could be a different number of lower fingers and although it has been found that multiple vertically offset fingers provides a margin of error for movement/positioning of the dish separator assembly, in an embodiment, a single lower finger could be used. Additionally, although certain dimensions are provided as examples, other dimensions are possible. In an embodiment, the upper and lower fingers are made from plastic, such as polyoxymethylene (POM), which exhibits high stiffness, low friction, and high dimensional stability, although other material may be used.

In an embodiment where a lift paddle of the dish stack lift system is lifted per dish type, the lift paddle may subsequently be moved down by a same or different amount (“Move lift down by type”) as specified for the type of the dish identified using machine vision. The top ware may then be engaged with a destack arm such that the destack arm one or both of holds the vertical position of the top ware and exerts an upward force on the ware, the separator is then retracted (“Retract separator”), and the destack arm will then remove the top ware and process it as described herein.

In an embodiment, the dish separator assemblies 10, 100, and 1100 are driven by motors to move the dish separator assemblies to engage and disengage with stacks of dishware. In one embodiment, multiple dish separator assemblies are driven by a common motor system and in other embodiment, each dish separator assembly is driven by its own motor system.

For storage density and in order to reduce human operator actions, dishes may be brought into the dish handling system in stacks on dish carts. Cleaning operations, whether scrubbing or otherwise, may be performed individually on dishes rather than stacks of dishes. Dishes may be parsed from the stack (e.g., separated and destacked) and transferred from the stack into another part of the dish handling system, such as a conveyance system for scrubbing. There are a number of challenges with manipulating dishes from a stack, individually. For example, dishes are often covered with unknown amounts, and types, of foods. Foods can bond to dishes, and can effectively bond dishes to each other. The dish handling system 102 and dish separator assemblies 10 and 100 are effective is separating dishes in a stack of dishes, including, in particular, for separating plates from a stack of plates and for separating bowls from a stack of bowls.

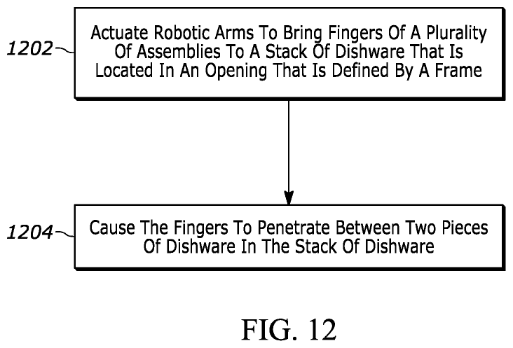

FIG. 12 is a process flow diagram of a method for separating stacked dishware. For example, the method utilizes an assembly as described herein. In an embodiment, the method involves, at block 1202, actuating robotic arms to bring fingers of a plurality of assemblies to a stack of dishware that is located in an opening that is defined by a frame, and at block 1204, causing the fingers to penetrate between two pieces of dishware in the stack of dishware.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus comprising:
a frame that defines an opening through which stacked dishware can pass; and
a plurality of assemblies connected to the frame and positioned around the opening, wherein each assembly includes;
a base; and
a plurality of fingers having a proximal end and a distal end, wherein the plurality of fingers are rotatably coupled to the base and extend from the base towards the opening, wherein each finger tapers towards the distal end.

2. The apparatus of claim 1, wherein the plurality of fingers are vertically offset from each other.

3. The apparatus of claim 1, wherein the plurality of fingers are vertically stacked relative to each other.

4. The apparatus of claim 1, wherein the tapering towards the distal end of each finger is configured to enable insertion between articles of dishware.

5. The apparatus of claim 1, wherein the plurality of fingers are rotatably coupled to the base at a pivot that permits rotation of the fingers relative to the base.

6. The apparatus of claim 1, wherein the plurality of fingers are rotatably coupled to the base such that the fingers rotate independently of each other.

7. The apparatus of claim 1, wherein each finger is rotatably coupled to the base by a tensioned pivot mechanism.

8. The apparatus of claim 1, wherein the plurality of fingers are rotatably coupled to the base at respective pivots that permit independent rotation of the fingers in two different directions relative to the base.

9. The apparatus of claim 1, wherein the assemblies include tension mechanisms configured to provide a return force independently to each finger in the plurality of fingers.

10. The apparatus of claim 1, wherein the assemblies are connected to respective robotic arms that are configured to move the assemblies relative to the opening that is defined by the frame.

11. The apparatus of claim 1, wherein a first set of the plurality of fingers is angled to fit between stacked bowls and a second set of the plurality of fingers is angled to fit between stacked plates.

12. The apparatus of claim 11, wherein the first set is vertically stacked above the second set.

13. The apparatus of claim 1, wherein the plurality of fingers includes:
a first set of fingers having a configuration; and
a second set of fingers having a configuration;
wherein the configuration of the first set of fingers is different from the configuration of the second set of fingers.

14. The apparatus of claim 1, wherein the plurality of fingers includes:
upper fingers having a configuration; and
lower fingers having a configuration;
wherein the configuration of the upper fingers is different from the configuration of the lower fingers.

15. The apparatus of claim 14, wherein:
the configuration of the upper fingers includes a length dimension;
the configuration of the lower fingers includes a length dimension; and
wherein the length dimension of the upper fingers is larger/longer than the length dimension of the lower fingers.

16. The apparatus of claim 14, wherein:
the configuration of the upper fingers includes an angular position at rest relative to a plane;
the configuration of the lower fingers includes an angular position at rest relative to the plane; and
wherein the angular position at rest of the upper fingers is greater than the angular position at rest of the lower fingers.

17. The apparatus of claim 14, wherein:
the configuration of the upper fingers includes a length dimension and an angular position at rest relative to a plane;
the configuration of the lower fingers includes a length dimension and an angular position at rest relative to the plane; and
wherein the length dimension of the upper fingers is larger than the length dimension of the lower fingers and wherein the angular position at rest of the upper fingers is greater than the angular position at rest of the lower fingers.

18. The apparatus of claim 1, wherein:
the plurality of fingers are rotatably coupled to the base at respective pivot points that permit independent rotation of the fingers in two different directions relative to the base; and
the assemblies include a compliant insert configured to provide a return force independently to each finger in the plurality of fingers.

19. A method for separating stacked dishware, the method comprising:
actuating robotic arms to bring fingers of a plurality of assemblies to a stack of dishware that is located in an opening that is defined by a frame; and
causing the fingers to penetrate between two pieces of dishware in the stack of dishware.

20. The method of claim 19, wherein each assembly includes a base and wherein the fingers are rotatably coupled to a respective base, and further comprising allowing the fingers to rotate about the respective bases as the fingers penetrate between two pieces of dishware in the stack of dishware.

21. The method of claim 19, wherein each assembly includes a plurality of vertically offset fingers.

22. The method of claim 19, wherein causing the fingers to penetrate between two pieces of dishware in the stack of dishware involves moving the dishware relative to the assemblies.

23. The method of claim 19, wherein the stack of dishware is a stack of bowls and wherein causing the fingers to penetrate between two pieces of dishware in the stack of dishware involves moving the stack of bowls towards the assemblies such that at least some of the fingers penetrate between two of the stacked bowls.

24. The method of claim 19, wherein causing the fingers to penetrate between two pieces of dishware in the stack of dishware involves moving the assemblies relative to the dishware.

25. The method of claim 19, wherein the stack of dishware is a stack of plates and wherein causing the fingers to penetrate between two pieces of dishware in the stack of dishware involves moving the assemblies towards the stack of plates such that at least some of the fingers penetrate between two of the stacked plates.

26. The method of claim 19, wherein causing the fingers to penetrate between two pieces of dishware in the stack of dishware involves 1) moving the stack of dishware towards the assemblies such that at least some of the fingers penetrate between two pieces of dishware when the stack of dishware is a stack of bowls, and 2) moving the assemblies towards the stack of dishware such that at least some of the fingers penetrate between two pieces of dishware when the stack of dishware is a stack of plates.

27. The method of claim 26, wherein 1) moving the stack of dishware towards the assemblies when the stack of dishware is a stack of bowls causes an upper set of fingers of each assembly to penetrate between at least two bowls in the stack of bowls, and 2) moving the assemblies towards the stack of dishware when the stack of dishware is a stack of plates causes a lower set of fingers of each assembly to penetrate between at least two plates in the stack of plates.
